(19) United States
(12) Patent Application Publication
(10) Pub. No.: US 2009/0240648 A1
(43) Pub. Date: Sep. 24, 2009

(54) EVALUATION METHOD OF NUMERIC ANALYSIS

(75) Inventor: Nobutaka ITOH, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/402,925

(22) Filed: Mar. 12, 2009

(30) Foreign Application Priority Data
Mar. 18, 2008 (JP) 2008-068771

(51) Int. Cl. G06N 7/04

(52) U.S. Cl. 706/54

(57) ABSTRACT

An evaluation method including associating the function blocks of the same kind in the first data and the second data is provided. The evaluation method includes specifying a specified function block from the function blocks, creating third data based on the first data and the specified function block of the second data, executing numeric analysis on the third data, comparing a numeric analysis data of the first data with a numeric analysis data of the third data and storing or displaying a comparison result.

### CROSS-REFERENCE TO RELATED APPLICATION

This application is related to and claims priority to Japanese Patent Application No. 2008-68771, filed on Mar. 18, 2008, and incorporated herein by reference.

### BACKGROUND

1. Field

The embodiments discussed herein are directed to a numeric analysis.

2. Description of the Related Art

Numeric analysis data includes individual functional element data, such as shape data, material characteristic data, a constraint condition, a contact condition, a load condition, and an analysis operation condition.

Knowledge, experience, and information correcting ability of a person who creates a model have an influence on a calculation result of analysis data. However, a third person can be incapable of determining the degree of precision of a result obtained from created analysis data only from the analysis data.

Also, even when the result is determined to be apparently inappropriate on the basis of the experience of the third person, a factor in new analysis data degrading the precision is not determined.

### SUMMARY

It is an aspect of the embodiments discussed herein to provide an evaluation method including associating the function blocks of the same kind in the first data and the second data, specifying a specified function block from the function blocks, creating third data based on the first data and the specified function block of the second data, executing numeric analysis on the third data, comparing a numeric analysis data of the first data with a numeric analysis data of the third data and storing or displaying a comparison result.

It is an aspect of the embodiments discussed herein to provide an evaluation device including a processor associating function blocks of a same kind in first data and second data, specifying a specified function block from the function blocks; creating third data based on the first data and the specified function block of the second data, executing numeric analysis on the third data, and comparing a numeric analysis data of the first data with a numeric analysis data of the third data; and a display displaying a comparison result.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an operation process of an evaluation method of a numeric analysis level according to an embodiment;

FIG. 2 illustrates a numeric analysis level evaluation device according to an embodiment;

FIG. 3 illustrates a schematic configuration of analysis data;

FIG. 4 illustrates a comparison of blocks;

FIG. 5 illustrates a structure of analysis data;

FIG. 6 illustrates specific analysis data based on general-purpose numeric analysis software and details of division into blocks;

FIG. 7 illustrates specific analysis data based on general-purpose numeric analysis software and details of division into blocks;

FIG. 8 illustrates specific analysis data based on general-purpose numeric analysis software and details of division into blocks;

FIG. 9 illustrates specific analysis data based on general-purpose numeric analysis software and details of division into blocks;

FIG. 10 illustrates specific analysis data based on general-purpose numeric analysis software and details of division into blocks;

FIG. 11 illustrates specific analysis data based on general-purpose numeric analysis software and details of division into blocks;

FIG. 12 illustrates specific analysis data based on general-purpose numeric analysis software and details of division into blocks;

FIG. 13 illustrates specific analysis data based on general-purpose numeric analysis software and details of division into blocks;

FIGS. 14A-14B illustrate exemplary comparison between blocks based on analysis data of general-purpose numeric analysis software;

FIG. 15 illustrates a unit of registering compared models and rewrite information;

FIG. 16 illustrates a block information registration unit;

FIG. 17 illustrates a data registration unit showing a configuration and result of analysis data;

FIG. 18 illustrates an exemplary procedure of operation S4 in FIG. 1;

FIG. 19 illustrates an exemplary procedure of operation S5 in FIG. 1;

FIG. 20 illustrates an exemplary procedure of operation S7 in FIG. 1;

FIG. 21 illustrates an analysis result information registration unit;

FIG. 22 illustrates analysis result data registration example 1;

FIGS. 23A-23B illustrate exemplary element set names of base analysis data and new analysis data for being specified by an operator;

FIGS. 24A-24B illustrate exemplary\material names of base analysis data and new analysis data for being specified by an operator; and

FIGS. 25A-25B illustrate exemplary differences in structure dimensions between base analysis data and new analysis data.

### DETAILED DESCRIPTION OF THE EMBODIMENTS

A program read from a hard disk device can be a recording medium or an external storage device (not illustrated) can be loaded to a main storage and started, whereby various processes described below can be performed.

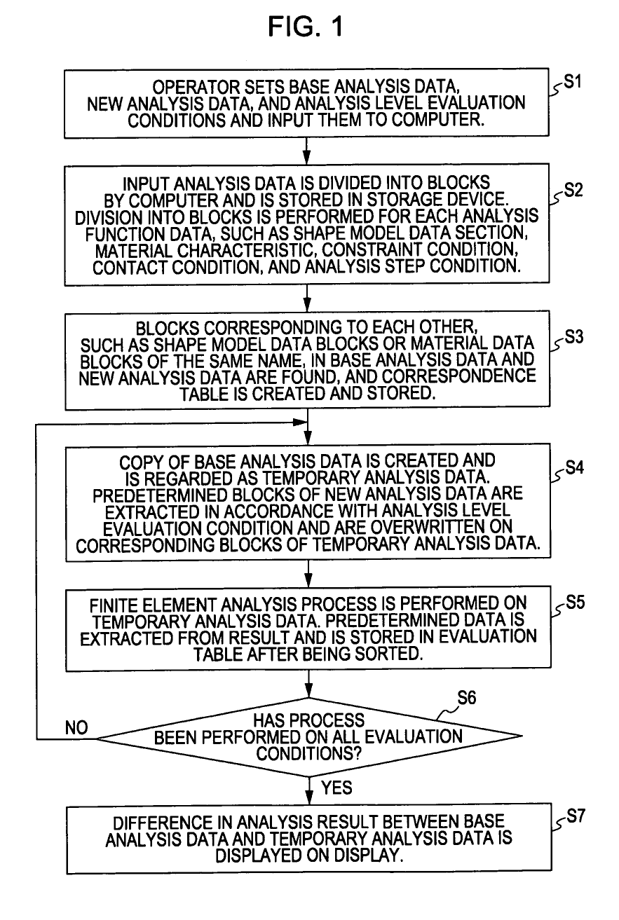

FIG. 1 illustrates a procedure of an operation process of an evaluation method of a numeric analysis level according to an embodiment.

Operation S1 in FIG. 1 includes specifying analysis data and setting conditions of analysis level evaluation. For example, an operator inputs file names of base analysis data and new analysis data, a comparison condition, and an analysis result extracting condition (analysis level evaluation conditions). A computer reads specified files from a storage device and stores the comparison condition and the analysis result extracting condition.

The comparison condition is a condition to perform temporary analysis by replacing data in data blocks corresponding to each other in two pieces of data of base analysis and new analysis, such as shape model data and material characteristic data. In default setting, the comparison condition includes shape model data and individual material characteristics. That is, the comparison condition can be set as the following combination in the default setting, and the operator can examine base analysis data and new analysis data in advance and input the comparison result and the combination.

1) Shape model data section

2) Individual material characteristics

3) All material characteristics having correspondence

The analysis result extracting condition includes a variable extracted for comparison from a numeric analysis result of two pieces of data of base analysis and new analysis, a numeric analysis operation range, and start time and end time of extraction.

Operation S2 in FIG. 1 includes dividing analysis data into blocks. For example, input analysis data can be divided into blocks by the computer and can be stored in the storage device. Division into blocks can be performed for each analysis function data, such as a shape model data section, a material characteristic, a node set, an element set, a constraint condition, a contact condition, and an analysis operation condition.

Operation S3 in FIG. 1 includes creating a block correspondence table. For example, blocks corresponding to each other, such as shape model data blocks or material data blocks of the same name, in the base analysis data and new analysis data are found, and a correspondence table is created and stored.

Operation S4 in FIG. 1 includes creating temporary analysis data. For example, a copy of base analysis data is created and is regarded as temporary analysis data. Blocks of the new analysis data are extracted in accordance with the analysis level evaluation condition set in operation S1 and are overwritten on the corresponding blocks of the temporary analysis data.

Operation S5 in FIG. 1 includes executing temporary analysis data and extracting a result. For example, a numeric analysis process can be performed on the temporary analysis data. Predetermined data is extracted from an analysis result together with the overwritten block information and can be stored by being sorted and added to an evaluation table on the basis of the specification in operation S1.

Operation S6 in FIG. 1 includes determining end. For example, it can be determined whether the process has been performed on all the specified evaluation conditions. If an evaluation condition remains, the process returns to operation S4. If the process has been performed on all the conditions, operation S7 is executed.

Operation S7 in FIG. 1 includes displaying difference between temporary analysis result and base analysis result. The difference in analysis result between the base analysis data and temporary analysis data is calculated, can be stored in the storage device, and can be displayed on a display.

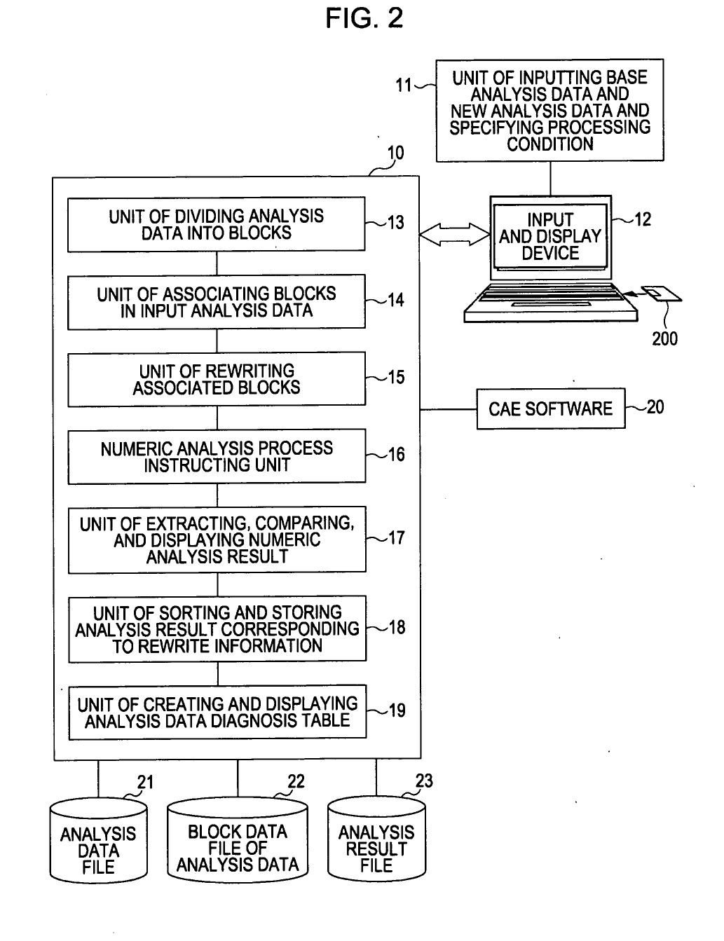

FIG. 2 illustrates a processing device according to an embodiment serving as a numeric analysis level evaluation device according to an embodiment. Reference numeral 10 denotes a processing device; 11 denotes a unit of inputting base analysis data and new analysis data and specifying a processing condition; 12 denotes an input and display device; 13 denotes a unit of dividing analysis data into blocks; 14 denotes a unit of associating blocks in input analysis data; 15 denotes a unit of rewriting associated blocks; 16 denotes a numeric analysis process instructing unit; 17 denotes a unit of extracting, comparing, and displaying a numeric analysis result; 18 denotes a unit of sorting and storing analysis result corresponding to rewrite information; 19 denotes a unit of creating and displaying an analysis data diagnosis table; 20 denotes a unit of storing and executing CAE (Computer Aided Engineering) software; 21 denotes an analysis data file; 22 denotes a block data file of analysis data; and 23 denotes an analysis result file. A program can A program/software implementing an embodiment may be recorded on a removable computer-readable media 200 comprising computer-readable recording media.

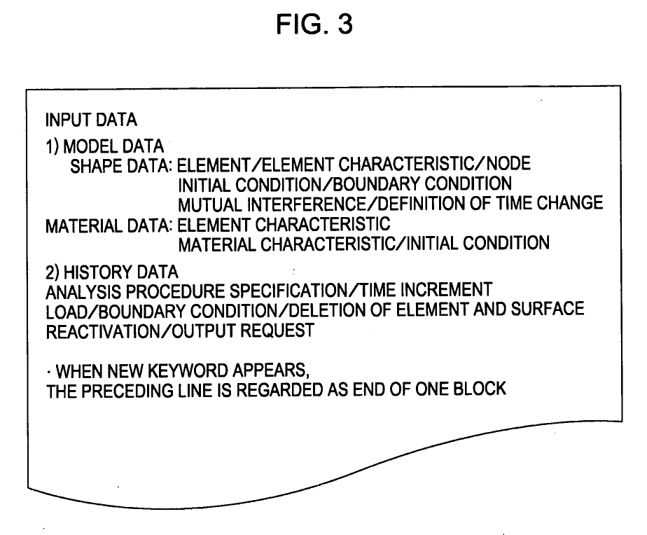

FIG. 3 illustrates a schematic configuration of typical analysis data. The analysis data roughly includes a model data section and a history data section.

In the model data section, the shape of an object to be analyzed is expressed by a combination of a node and an element and element characteristic definition. The relationship between an element set and material can be described in the element characteristic definition. Also, a material characteristic can be defined for the name of each material of the object. Material data includes data of material name, Young's modulus, Poisson's ratio, and thermal expansion coefficient. Also, an initial condition including a temperature definition at the start of numeric analysis of the object can be described as the material data.

The history data section includes procedure specification including linear analysis, nonlinear analysis, thermal conduction analysis, and vibration analysis, time increment, load, definition and change of boundary condition, temporary erasure and reactivation of element and surface definition, and output request.

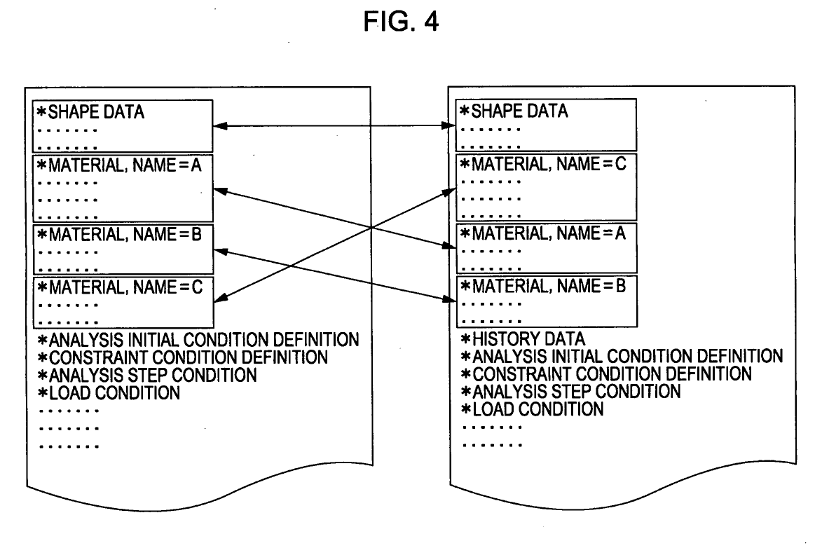

FIG. 4 illustrates a comparison of blocks.

Shape data includes a first node description card at its head and description of node information and several element sets. The line immediately preceding the line where a card other than a node or element definition appears can be the end of the shape model block.

Material definition includes a card of material name at its head, and Young's modulus, Poisson's ratio, and thermal expansion coefficient are described. The line immediately preceding the line where a card other than next material definition or material definition relationship appears is the end of the material definition block.

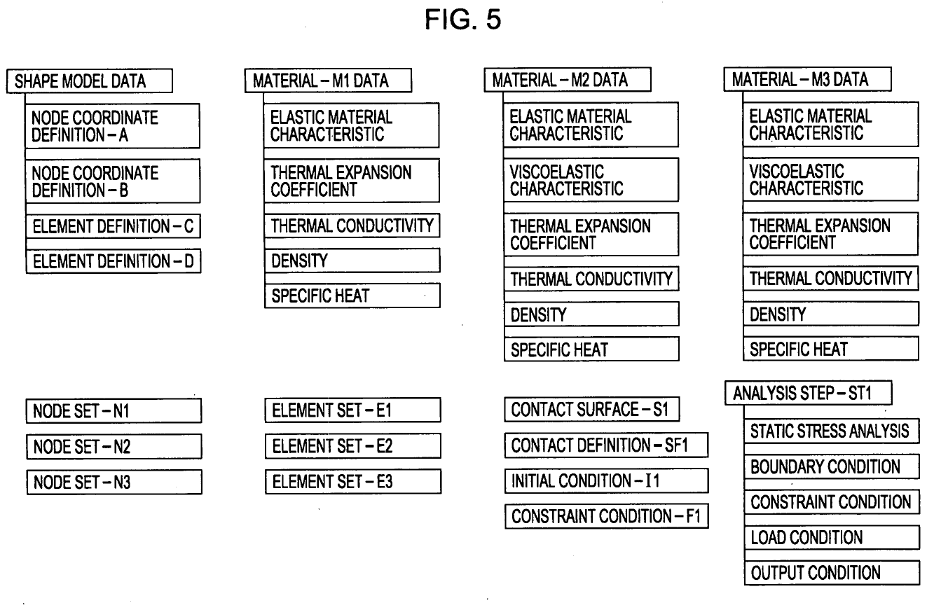

FIG. 5 illustrates a structure of analysis data. That is, FIG. 5 specifically illustrates the operation of dividing analysis data into blocks in operation S2 in FIG. 1.

In the analysis data, each data group of node coordinate values, elements, material characteristics, contact surfaces, and a set of load surface elements has a unique name. A data line immediately preceding the line at the start of data definition not belonging to a data group is regarded as the end of a block.

The shape model data section is data including all sets of node coordinate value definitions and sets of element definitions.

The material data block is data about one material including all characteristics, such as a mechanical characteristic and a thermal characteristic.

A node set and an element set can be independently defined, and a set name can be used in contact surface definition, boundary condition, constraint condition, and load condition. For example, a node set defines a constraint condition or a load condition by using its name. An element set defines a contact surface or a uniformly-distributed load by using its name.

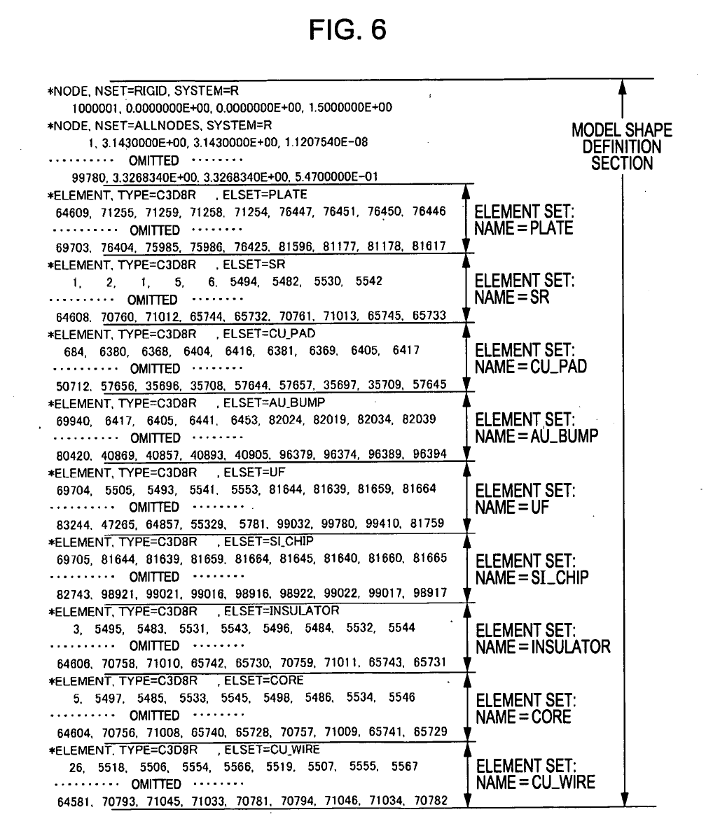

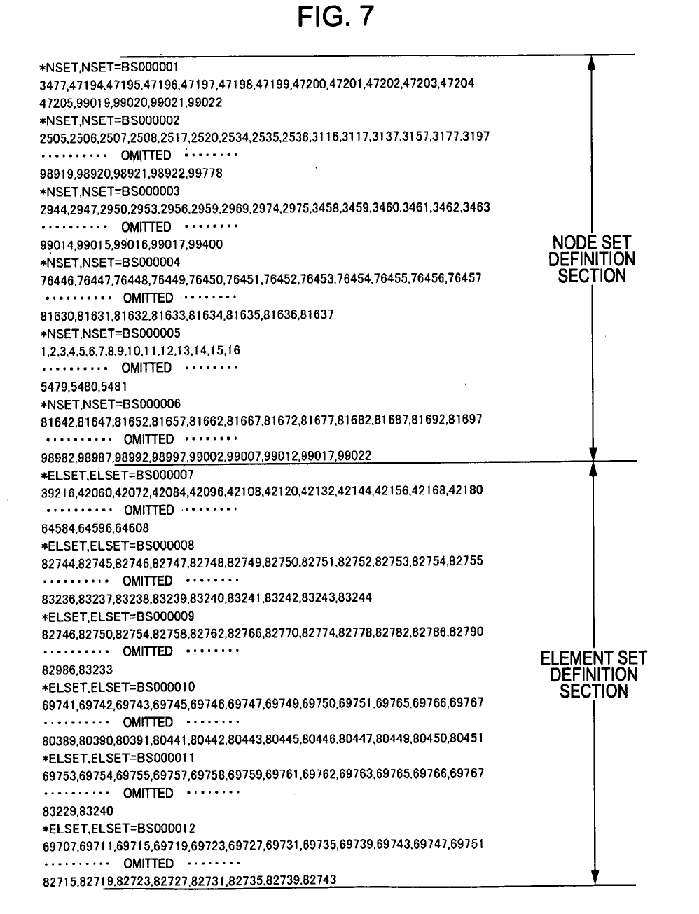

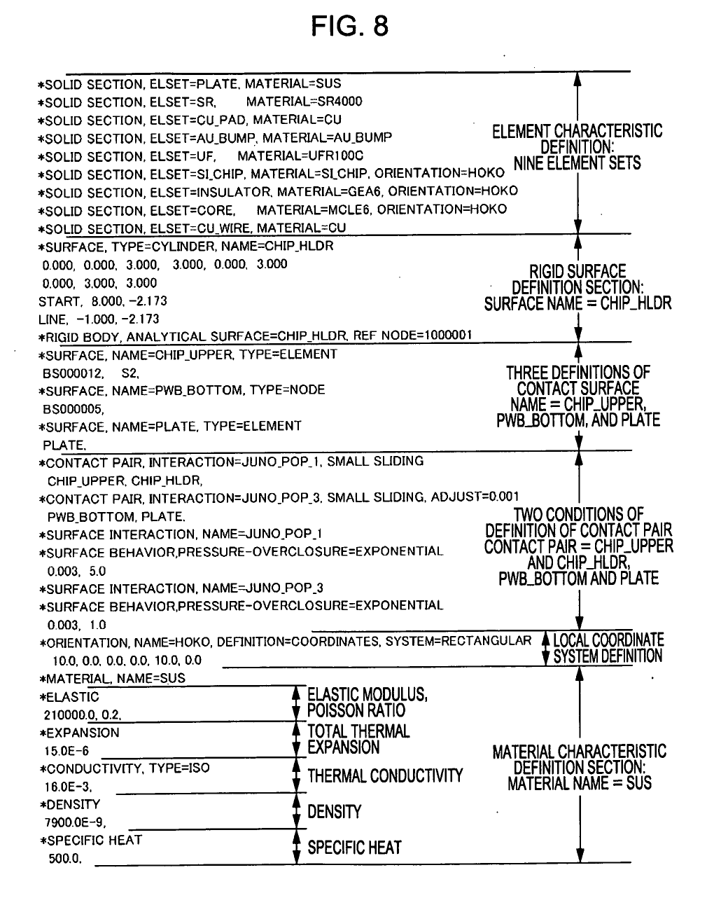

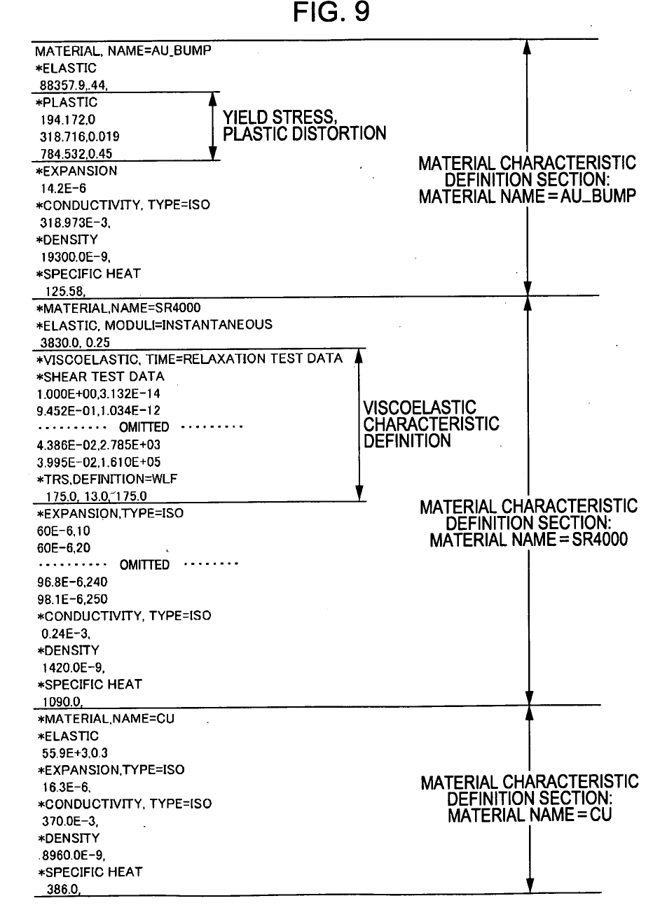

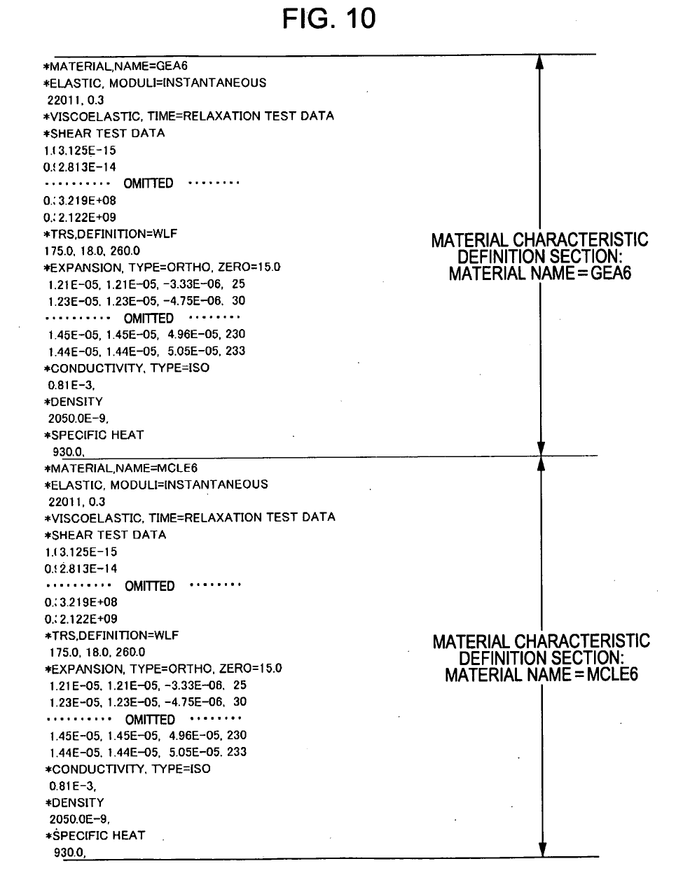

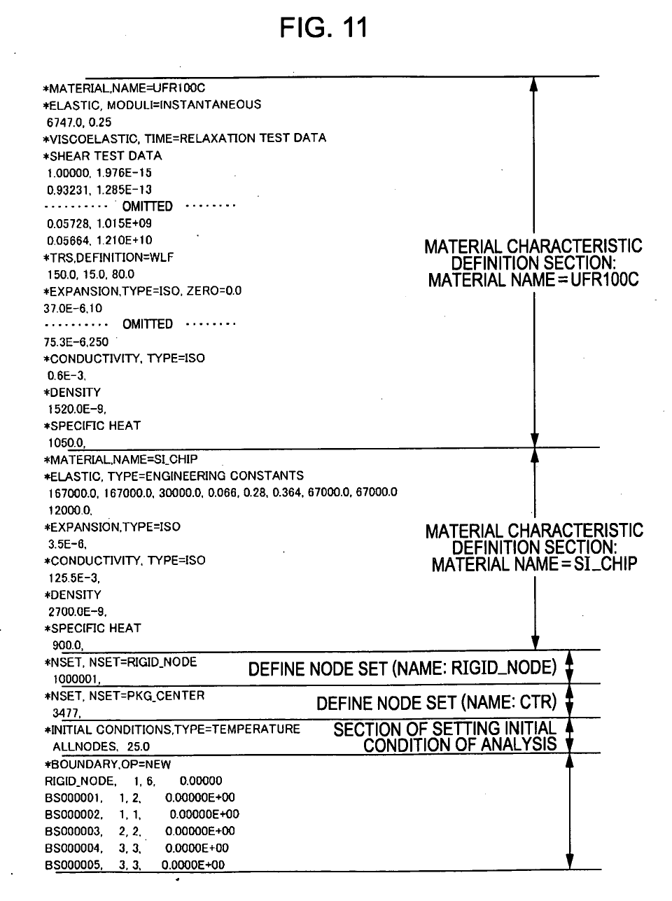

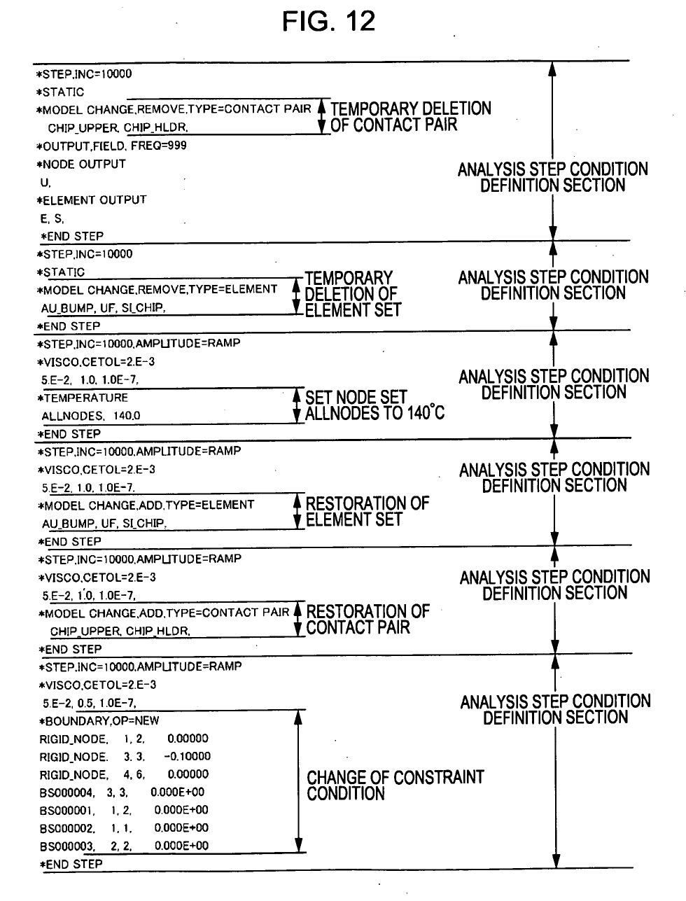

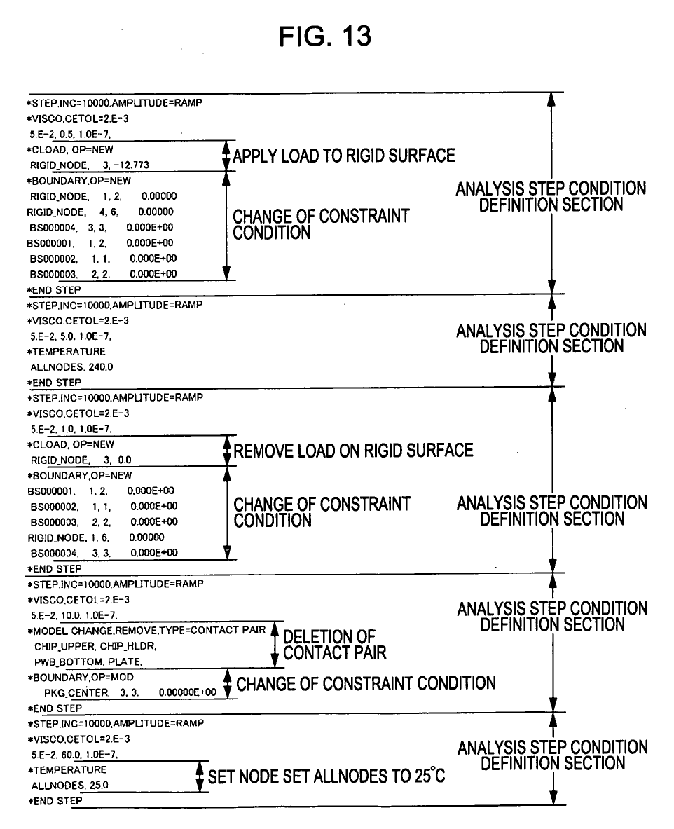

FIGS. 6 to 13 illustrate exemplary specific analysis data based on general-purpose numeric analysis software, and specifically illustrate division into blocks.

The model shape definition section starts from a card of *NODE. “ALL” following “NSET” is the name of a node set that is to be defined. The part immediately preceding a card of *ELEMENT is the end the node definition section.

In the element definition, the name following “TYPE” in the line starting with *ELEMENT indicates an element type, and the name following “ELSET” is the name of an element set that is to be defined. The part immediately preceding the next *ELEMENT line or other card is the end of one element set definition.

The material definition section starts from a card of *MATERIAL. The name following “NAME” is the name of the material that is to be defined. The part immediately preceding another *MATERIAL or a card other than material definition is the end of one material definition block.

The initial condition definition starts from a card of *INITIAL CONDITION. The name following “TYPE” indicates the content of the initial condition that is to be defined. “TEMPERATURE” indicates that this is an initial temperature definition. The node set name giving initial temperature and the initial temperature are given after this card. The part immediately preceding a card starting from * and an alphabet is the end of the initial condition definition block.

The boundary condition definition section starts from a card of *BOUNDARY. The name following “OP” indicates whether the boundary condition that is to be defined is newly given or the already given condition is to be changed. “NEW” indicates a new definition. Node number, degree of freedom of constraint, and value are described in that order. The part immediately preceding a card starting from * and an alphabet is the end of the boundary condition definition block.

The part from a card of *OPERATION to *END OPERATION is one section of an analysis process.
*VISCO indicates viscoelastic unsteady analysis.
Temperature specification starts from a card of *TEMPERATURE. The part immediately preceding a card starting from * and an alphabet is the end of the heat flux definition block.
A card starting from *OUTPUT is the output condition definition.

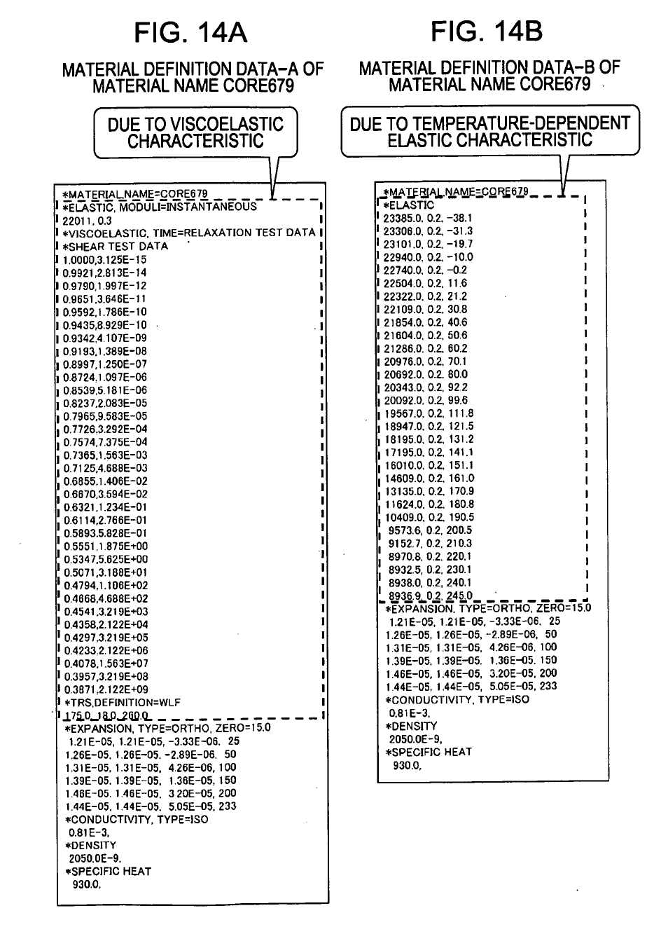

FIGS. 14A-14B illustrate exemplary blocks based on the analysis data of the above-described general-purpose numeric analysis software and illustrates a case of the same material and different characteristic definitions. The material definition blocks placed on the right and left are data of the material name CORE679. The left one is viscoelastic characteristic material definition starting from a card of *VISCOELASTIC, whereas the right one is temperature-dependent elastic modulus data starting from a card of *ELASTIC. The both pieces of data are not regarded as good or bad. The data on the left shows the viscoelastic characteristic obtained from a result of actual measurement performed in the company, whereas the data on the right is test data provided by a material manufacture, for example.

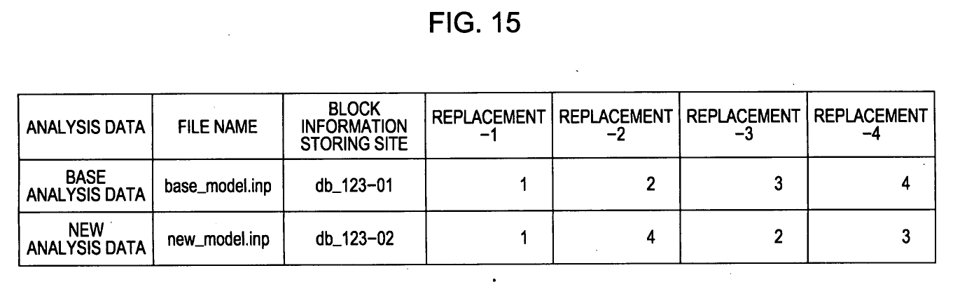

FIG. 15 illustrates a unit of registering compared analysis data and rewrite information.

In operation S1 in FIG. 1, two pieces of analysis data: base analysis data and new analysis data, are specified by the operator, and the two model names and two file names are stored here through computer processing.

Also, addresses of the block information registration data created in operation S2 in FIG. 1 are stored in the field of a block information storing site. Furthermore, in operation S3 in FIG. 1, shape model definition blocks or blocks of the same material name are identified in the block information registration data created in operation S2. If corresponding blocks in the base analysis data and new analysis data are found, the numbers of those blocks are sequentially stored in the replacement fields of the unit of registering compared analysis data and rewrite information.

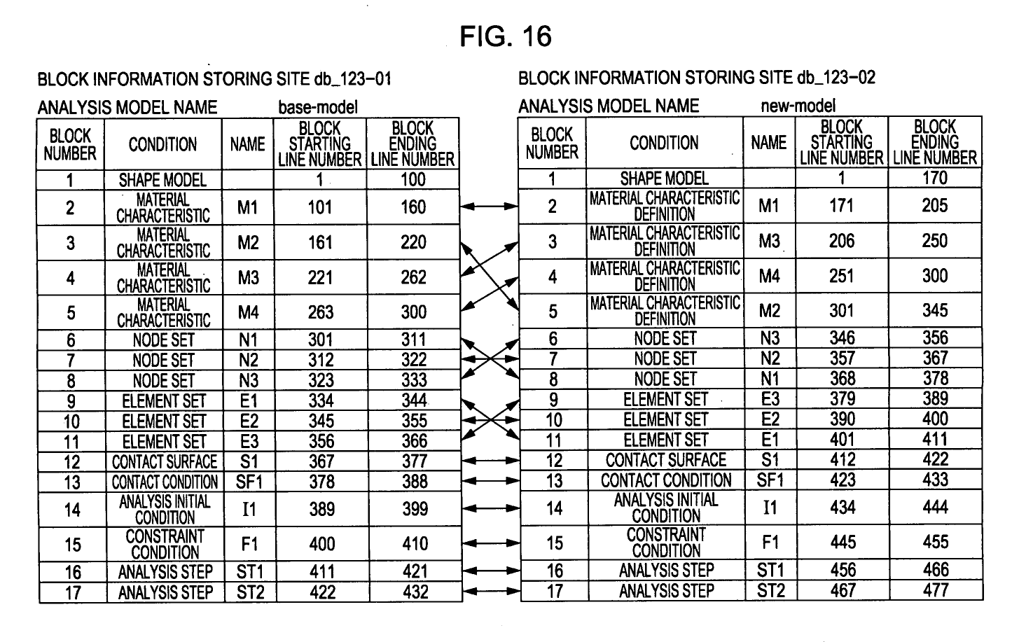

FIG. 16 illustrates a block information registration unit.

In operation S2 in FIG. 1, each of the input base analysis data and new analysis data is divided into blocks. The data line numbers at the start and end of the respective blocks, such as a shape model section, a material definition section, and a constraint condition definition section, are registered. Also, if a name such as a material name is provided for block definition, the name is registered. In FIG. 16, arrows indicate the correspondence between blocks in the base analysis data and new analysis data.

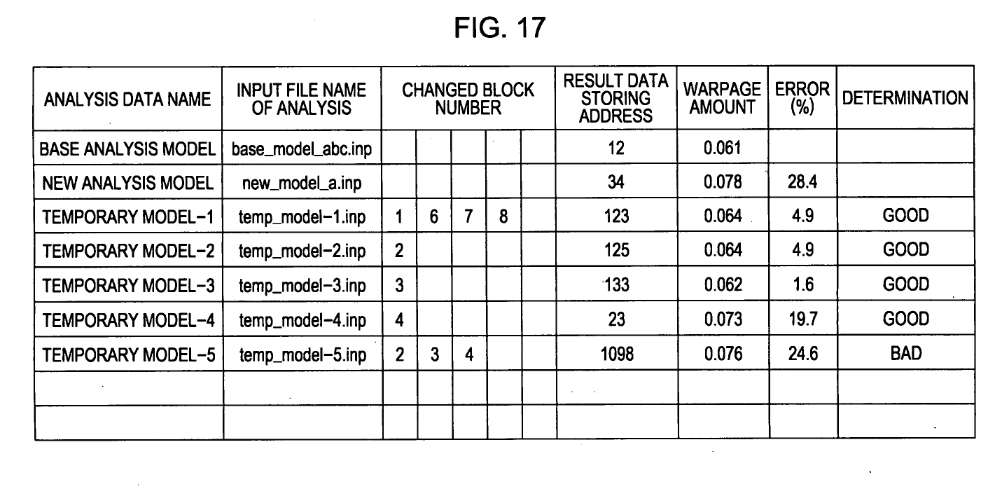

FIG. 17 illustrates a data registration unit showing a configuration and result of analysis data.

A data file name, a data block number changed from the base analysis data, a result data storing address, final evaluation data such as warpage amount, an error from a reference analysis result, and a determination value (good or bad) of a replaced block are processed by the computer and are registered for each of the base analysis data, new analysis data, and temporary analysis data. In the good or bad determination of replaced blocks, if the error is smaller than a reference determination value preset in the system (20% in this case), it is determined to be good. Otherwise, it is determined to be bad. The reference determination value can be changed by the operator.

In accordance with the file names of the base analysis data and new analysis data, the comparison condition, and the analysis result extracting condition that are specified by the operator in operation S1 in FIG. 1, the name and file name of the temporary analysis data that is to be newly created and the block number changed from the base analysis data are stored. Then, the temporary analysis data is created According to an embodiment, numeric analysis is executed, and a result is extracted and registered. At the same time, errors are calculated and registered. The individual errors are compared with the reference determination value and the determination of good or bad is made and registered. The changed block numbers shown in FIG. 17 are based on a default combination.

In temporary model-1, block number 1 of the shape model data definition section and block numbers 6, 7, and 8 for defining a constraint condition are simultaneously replaced. In the replacement of the shape model data definition, the inside of the analysis operation is checked. If load or change of a constraint condition is defined and if an element set and a node set are used therein, data is replaced by using the block numbers corresponding to those sets. Here, a result of numeric analysis indicates a warpage amount of 0.064 and also indicates that the error is 4.9% compared with the warpage amount of 0.061 in the result of base analysis.

In temporary model-2, the material characteristic data definition section of block number 2 is replaced. A result of numeric analysis indicates a warpage amount of 0.064 and also indicates that the error is 4.9% compared with the warpage amount of 0.061 in the result of base analysis. Since the error is smaller than the reference determination value of 20%, the determination result is good.

In temporary model-3, the material characteristic data definition section of block number 3 is replaced. A result of numeric analysis indicates a warpage amount of 0.062 and also indicates that the error is 1.6% compared with the warpage amount of 0.061 in the result of base analysis. Since the error is smaller than the reference determination value of 20%, the determination result is good.

In temporary model-4, the material characteristic data definition section of block number 4 is replaced. A result of numeric analysis indicates a warpage amount of 0.073 and also indicates that the error is 19.7% compared with the warpage amount of 0.061 in the result of base analysis. Since the error is smaller than the reference determination value of 20%, the determination result is good.

In temporary model-5, the material characteristic data definition sections of block numbers 2, 3, and 4 are replaced. A result of numeric analysis indicates a warpage amount of 0.076 and also indicates that the error is 24.6% compared with the warpage amount of 0.061 in the result of base analysis. Since the error is larger than the reference determination value of 20%, the determination result is bad.

According to the above-described result, it can be determined that the shape model definition section and the material characteristic data of block numbers 2 and 3 cause a small error even when being replaced by blocks of the base analysis data and have a little problem as analysis data. On the other hand, when the material characteristic data of block number 4 is replaced, the calculation result indicates that the error from the analysis result of the base analysis data is large in 19.6%. When the material characteristics of block numbers 2, 3, and 4 are simultaneously replaced, the error exceeds the reference determination value of 20%, that is, 24.6%. Therefore, it can be understood that the material characteristic of block number 4 is within an allowable error range when it is independently replaced but is a factor of large difference from the base analysis data in the entire new analysis data. Then, the system notifies the operator through display that the data of block number 4 needs to be reviewed. The operator reviews the new analysis data in accordance with alarm of the system. However, the operator can ignore the alarm if they know that the material characteristic data of block number 4 is used under recognition that the material characteristic data has a nature significantly different from that of the material characteristic used in the base analysis data.

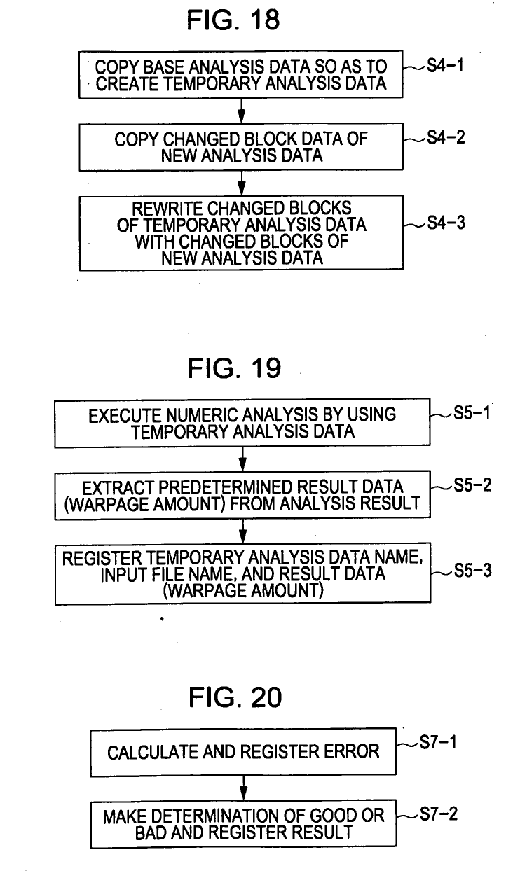

FIG. 18 illustrates an exemplary procedure of operation S4 in FIG. 1.

The base analysis data is copied, so that temporary analysis data is created (operation S4-1), changed block data of the new analysis data is copied (operation S4-2), and changed blocks of the temporary analysis data are rewritten with changed blocks of the new analysis data (operation S4-3).

FIG. 19 illustrates an exemplary procedure of operation S5 in FIG. 1.

Numeric analysis is executed by using the temporary analysis data (operation S5-1), predetermined result data (warpage amount) is extracted from an analysis result (operation S5-2), and temporary analysis data name, input file name, and result data (warpage amount) are registered (operation S5-3).

FIG. 20 illustrates an exemplary procedure of operation S7 in FIG. 1.

An error is calculated and registered (operation S7-1), determination of good or bad is made and the determination result is registered (operation S7-2).

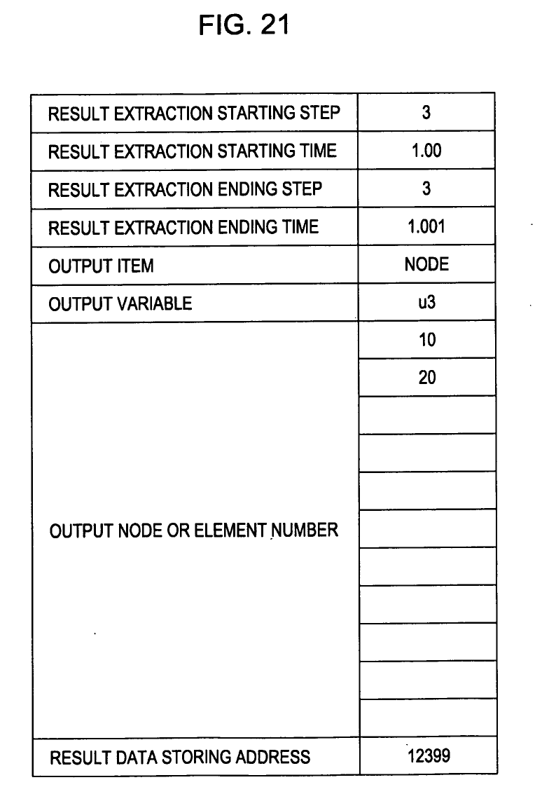

FIG. 21 illustrates an analysis result information registration unit.

Numeric analysis calculation of each temporary analysis data is executed in operation S5 in FIG. 1. A result extracting range, the names of variables to be extracted, and node numbers to be output are stored here in advance in operation S1 in FIG. 1. Also, an analysis result data storing address is described here. In this example, extraction of data of variable U3 of node numbers 10 and 20 is specified only in the last time 1.00 of the third operation in the analysis result.

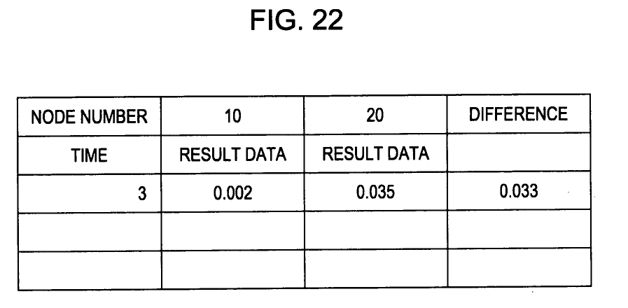

FIG. 22 illustrates analysis result data registration.

U3 data of node numbers 10 and 20 can be extracted and stored here in the last time of the third operation of the analysis. Also, the difference between both sides is calculated and is described in the field of difference. At the same time, the data of the difference can be described in the field of the analysis result in the table of changed blocks from the base analysis data illustrated in FIG. 16.

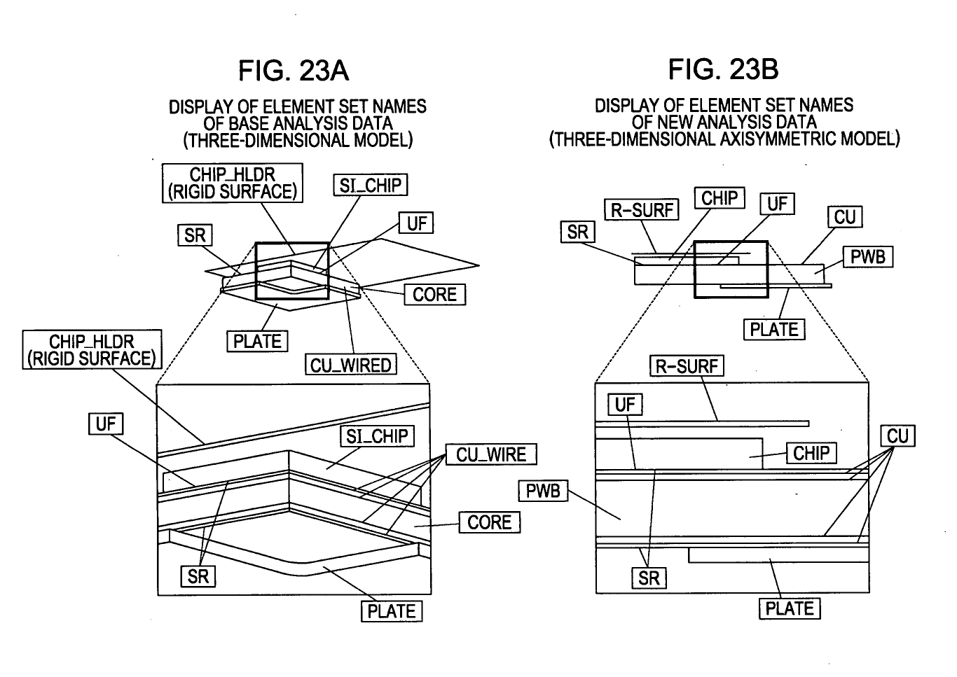

FIGS. 23A-23B illustrate base analysis data and the new analysis data actually correspond to each other and where the operator teaches the correspondence if the base analysis data does not match the new analysis data when search can be performed by using an element set name.

In operation S1 in FIG. 1, the operator can allow the base analysis data and new analysis data to be simultaneously displayed on the right and left and specify the correspondence between components having the same function even if the components have different names while indicating the components in a dialogical manner. According to an embodiment, division into blocks can be performed later.

In FIGS. 23A-23B illustrate tags indicate the names given to element sets corresponding to the respective components.

In FIGS. 23A-23B, the correspondence specified by the operator includes CU_WIRE and CU, SI_CHIP and CHIP, CHIP_HLDR and R-SURF, and CORE and PWB.

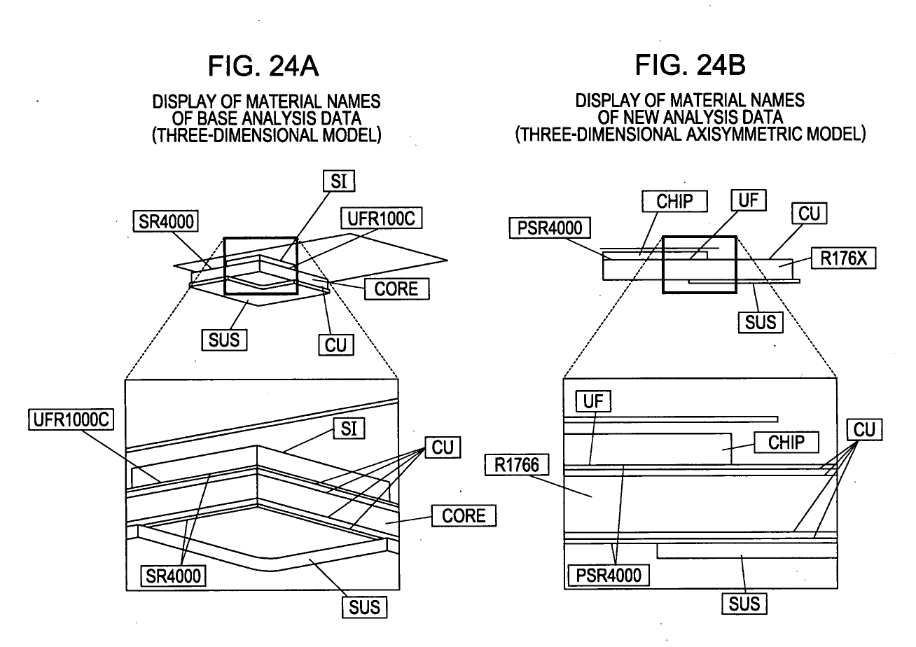

FIGS. 24A-24B illustrate exemplary displays where the base analysis data and the new analysis data actually correspond to each other and where the operator teaches the correspondence if the base analysis data does not match the new analysis data when search can be performed by using a material name.

In operation S1 in FIG. 1, the operator can allow the base analysis data and new analysis data to be simultaneously displayed on the right and left and specify the correspondence between the same materials even if the materials have different names while indicating the components in a dialogical manner. According to an embodiment, division into blocks can be performed later.

In FIGS. 24A-24B, tags indicate the material names of the respective components.

Also, in FIGS. 24A-24B, the material names and element set names given to the components of the base analysis data and new analysis data have no correspondence. The correspondence includes SR4000 and PSR4000, SI and CHIP, UFR1000C and UF, and CORE and R176X.

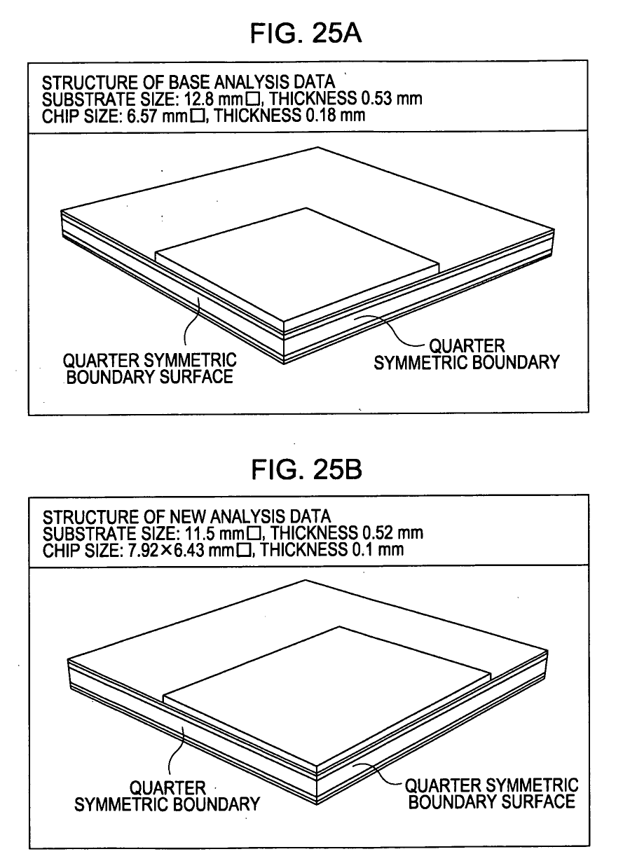

FIGS. 25A-25B illustrate differences in structure dimensions between the base analysis data and new analysis data.

Both pieces of data have a similar structure including a chip mounted on a substrate and are modeled with three-dimensional solid elements, but are different in dimensions of the substrate and the chip.

According to an embodiment, an influence on precision due to a difference in shape model definition section of new analysis data with respect to base analysis data can be predicted.

Also, according to an embodiment, a difference from base analysis data can be clearly seen in respective material characteristics of new analysis data, so that an influence on calculation precision can be determined.

Furthermore, according to an embodiment, extracted data can be compared with a base analysis result on which numeric analysis can be performed in advance, and the difference between a temporary analysis result and the base analysis result is stored and displayed. Accordingly, the difference between new analysis and base analysis can be automatically calculated and the appropriateness of new analysis data can be determined. When the difference in result between base analysis and temporary analysis exceeds an allowable analysis error value, it can be determined that the factor of the large error exists in the replaced part in the temporary analysis data.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An evaluation method of numeric analysis comparing first data storing a base numeric analysis and second data storing another numeric analysis, the first data and the second data each having a plurality of function blocks, the evaluation method comprising:
associating the function blocks of the same kind in the first data and the second data;
specifying a specified function block from the function blocks;
creating third data based on the first data and the specified function block of the second data;
executing numeric analysis on the third data;
comparing a numeric analysis data of the first data with a numeric analysis data of the third data; and
storing or displaying a comparison result.

2. The evaluation method according to claim 1, wherein, if the function blocks of a plurality of same types have been detected between the first data and the second data, a plurality of pieces of the third data are created for each of the function blocks.

3. The evaluation method according to claim 2, wherein one of the pieces of the third data is created by rewriting the block of material definition.

4. The evaluation method according to claim 1, further comprising:
displaying the first data and the second data in a display device; and
specifying the function blocks of the same type through operation of an input device by an operator.

5. The evaluation method according to claim 4, wherein constraint conditions, load conditions, and contact surface definitions of both the first data and second data are displayed.

6. An evaluation device comprising:
a processor associating function blocks of a same kind in first data and second data, specifying a specified function block from the function blocks; creating third data based on the first data and the specified function block of the second data, executing numeric analysis on the third data, and comparing a numeric analysis data of the first data with a numeric analysis data of the third data; and
a display displaying a comparison result.
